(19) United States
(12) Patent Application Publication
(10) Pub. No.: US 2012/0316957 A1
(43) Pub. Date: Dec. 13, 2012

(54) SIMULATING AN ADVERTISING AUCTION

(75) Inventors: ENKAI ZHOU, BEIJING (CN); CHEN OUYANG, BEIJING (CN); MING FAN, REDMOND, WA (US); XUEJIAN PAN, REDMOND, WA (US); SINAN ZHAN, BEIJING (CN); JIANHUA HU, BEIJING (CN)

(73) Assignee: MICROSOFT CORPORATION, REDMOND, WA (US)

(21) Appl. No.: 13/158,696

(22) Filed: Jun. 13, 2011

(51) Int. Cl. G06Q 30/00

(52) U.S. Cl. 705/14.46

(57) ABSTRACT

Methods, systems, and computer-readable media for simulating advertising auction results for a listing using auction data from auctions in which the listing previously participated. The simulation allows an advertiser to determine a bid price that would have resulted in a particular outcome. The simulation may be performed by rerunning auctions in which the listing participated by maintaining the characteristics of all other bids that actually participated in the auction while changing the bid price for the listing being simulated. The simulation may be repeated multiple times with different bid prices to create a distribution of auction results that correspond to various bid prices.

### BACKGROUND

Online advertising exchanges let advertisers purchase online advertising space from publishers. Publishers (content and property owners) may auction the advertising space to advertisers using cost-per-click, cost-per-impression, or another pricing model. The types of advertisements that may be sold at auction include paid search results, banner ads, on-page advertisements, television, radio, and other. Advertisers and publishers constantly adjust their asks or bids to optimize the return on their purchase or sale.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention simulate advertising auction results for a listing using auction data from auctions in which the listing previously participated. The simulation allows an advertiser to determine a bid price that would have resulted in a particular outcome. For example, the simulation may allow an advertiser to find the hypothetical bid price that would have resulted in 1,000 impressions for the listing over the last week. In another example, the simulation would allow the advertiser to know the results, including the cost of the campaign, had a particular hypothetical bid price been used. In one embodiment, the simulation is performed by rerunning auctions in which the listing participated by maintaining the characteristics of all other bids that actually participated in the auction while changing the bid price for the listing being simulated. The simulation may be repeated multiple times with different bid prices to create a distribution of auction results that correspond to various bid prices.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of a computing system architecture suitable for conducting auction simulations, in accordance with an embodiment of the present invention;

FIG. 3 is a diagram illustrating how a listing performed in a group of auctions in which a listing participated with a first bid price, in accordance with an embodiment of the present invention;

FIG. 4 is a diagram illustrating how the listing performed when the group of auctions in which a listing participated were rerun with a simulated bid price for the listing, in accordance with an embodiment of the present invention;

FIG. 5 is flow chart showing a method of generating simulated auction results for an advertising listing, in accordance with an embodiment of the present invention;

FIG. 6 is flow chart showing a method of simulating advertising auctions for a listing using historical data from actual auctions in which a listing participated, in accordance with an embodiment of the present invention; and

FIG. 7 is a flow chart showing a method of generating simulated auction results for a listing using historical data from advertising auctions in which the listing previously participated, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention simulate advertising auction results for a listing using auction data from auctions in which the listing previously participated. The simulation allows an advertiser to determine a bid price that would have resulted in a particular outcome. For example, the simulation may allow an advertiser to find the hypothetical bid price that would have resulted in 1,000 impressions for the listing over the last week. In another example, the simulation would allow the advertiser to know the results, including the cost of the campaign, had a particular hypothetical bid price been used. In one embodiment, the simulation is performed by rerunning auctions in which the listing participated by maintaining the characteristics of all other bids that actually participated in the auction while changing the bid price for the listing being simulated. The simulation may be repeated multiple times with different bid prices to create a distribution of auction results that correspond to various bid prices.

Having briefly described an overview of embodiments of the invention, an exemplary operating environment suitable for use in implementing embodiments of the invention is described below.

### Exemplary Operating Environment

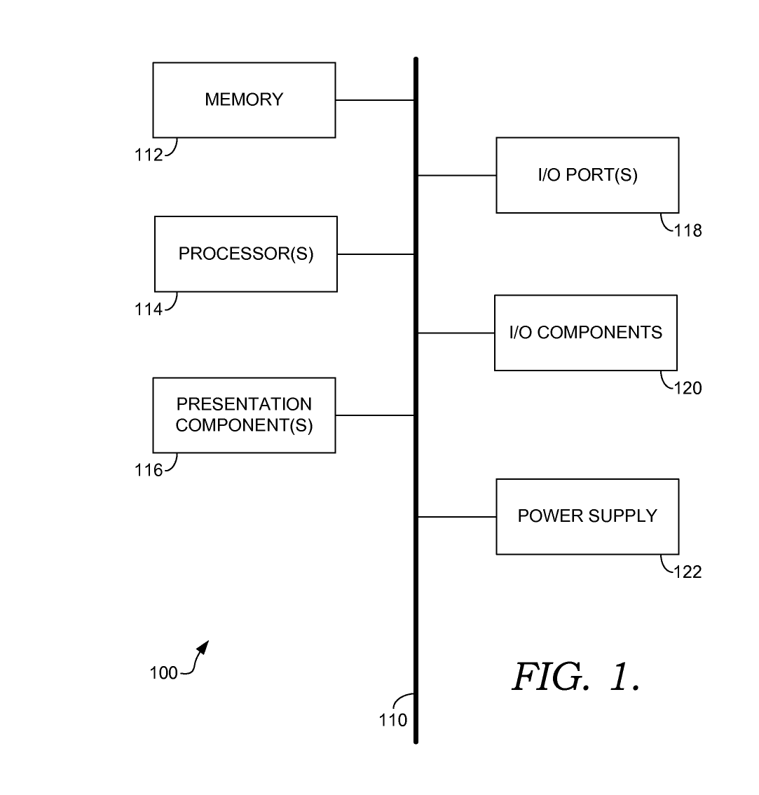

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-storage media. By way of example, and not limitation, computer-storage media may comprise Random Access Memory (RAM); Read Only Memory (ROM); Electronically Erasable Programmable Read Only Memory (EEPROM); flash memory or other memory technologies; Compact Disk Read-Only Memory (CDROM), digital versatile disks (DVDs) or other optical or holographic media; magnetic cassettes, magnetic tape, magnetic disk storage or other magnetic storage devices; or any other medium that can be used to encode desired information and be accessed by computing device 100. Computer-storage media may be non-transitory.

Memory 112 includes computer-storage media in the form of volatile and/or nonvolatile memory. The memory 112 may be removable, non-removable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary System Architecture

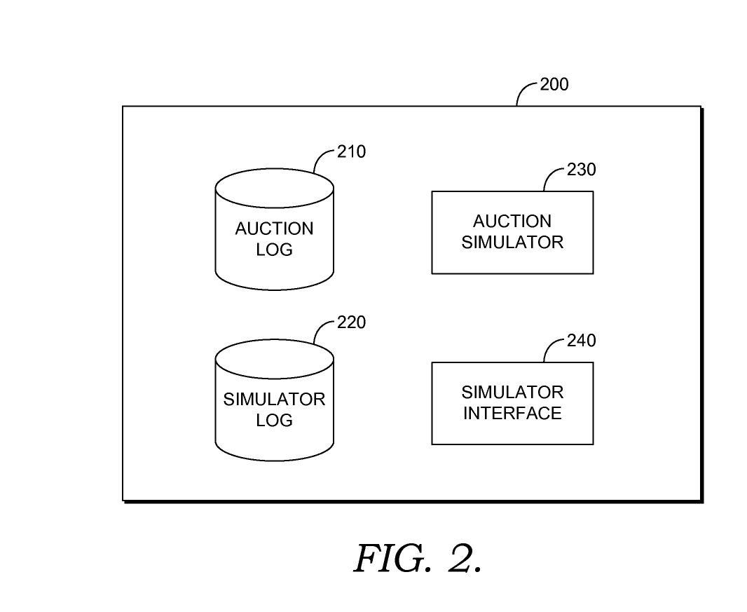

Turning now to FIG. 2, an exemplary computing system architecture 200 suitable for simulating advertising auctions is shown, in accordance with an embodiment of the present invention. The computing system architecture 200 shown in FIG. 2 is an example of one suitable computing system architecture 200. The computing system architecture 200 comprises on one or more computing devices similar to the computing device 100 described with reference to FIG. 1. The computing system architecture 200 should not be interpreted as having any dependency or requirement related to any single module/component or combination of modules/components illustrated therein. The computing system architecture 200 includes an auction log 210, a simulator log 220, an auction simulator 230, and a simulator interface 240. The computing system architecture 200 may be part of, or used with, an online advertising exchange (not shown). The online advertising exchange helps publishers sell ad space to advertisers, including paid search results.

The auction log 210 stores auction data from previously conducted auctions. The auction data includes bid characteristics for a plurality of listings. A listing may be an advertisement, such as a paid search result or a banner ad on a web page. The bid characteristics include a bid price, a match type, and a keyword. The match type specifies the type of match required for a listing to participate in an auction. The match in questions may be between terms within publishing content (e.g., a search term, content on a web page) and one or more keywords designated by the listing. For example, if the match type is exact then all of the specified keywords needs to appear in the exact order specified within a query or within text on a web page associated with the advertising space. Other match types may allow some of the keywords of the listing to be optional, or appear in a different sequence than what is in the query or the text on the web page. Other types of matching may allow derivatives or synonyms for the one or more keywords to qualify as matches.

The auction log 210 stores data from completed auctions. Data generated by a completed auction includes bid prices for each listing that participated in the auction, historical performance data for each listing (e.g., click-through-rate (“CTR”)), actual performance of the one or more listings that were displayed as a result of the auction, and ranks for each listing. Other data may also be stored. The rank may be used to determine which listings win the auction and receive an impression. An impression is a single instance of displaying the listing. The completed auction data is later used to rerun the auction while changing one or more bid characteristics associated with a listing.

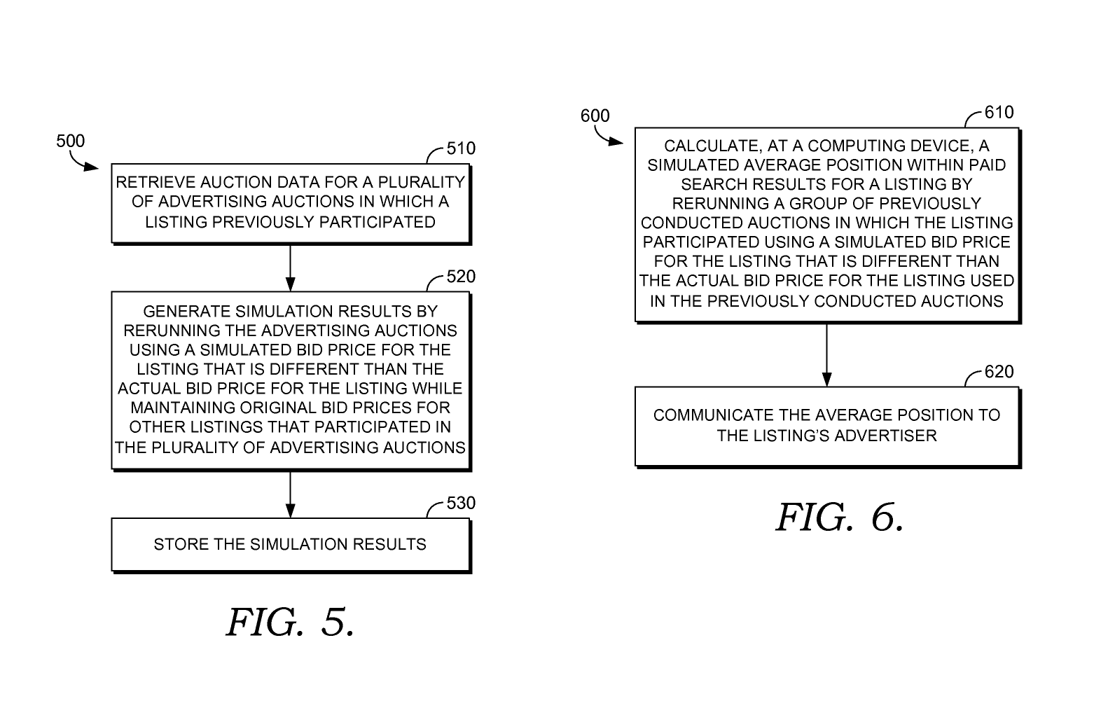

The simulator log 220 stores the results of auction simulations for later consumption by an advertiser. The methods used to perform auction simulations will be described in more detail with the reference to FIGS. 5-7. The simulation results may be presented through the simulator interface 240 the next time an advertiser uses the interface or specifically requests simulation results. Embodiments of the present invention are not limited to use of a simulator log 220. For example, simulations could be run on demand when requested by an advertiser.

The auction simulator 230 conducts auction simulations for individual listings. The results of the auction simulation may be stored in the auction simulator log 220. The auction simulator 230 uses data from previously conducted auctions in which a listing participated to simulate auction results for the listing. Again, a description of the simulation method used by the auction simulator is described in more detail with the reference to FIGS. 5-7.

The simulator interface 240 presents simulated auction results and allows an advertiser to request simulated auction data for a particular listing under specified conditions. The specified conditions, such as bid price, desired impressions, cost per click (“CPC”), and other parameters might be entered through the simulator interface 240. The simulator interface may generate a graphical user interface that is communicated to the user over a network and shown in a browser. Other types of interfaces may also be used. In one embodiment, the simulator interface 240 communicates and receives information from a client application associated with the advertising campaigns.

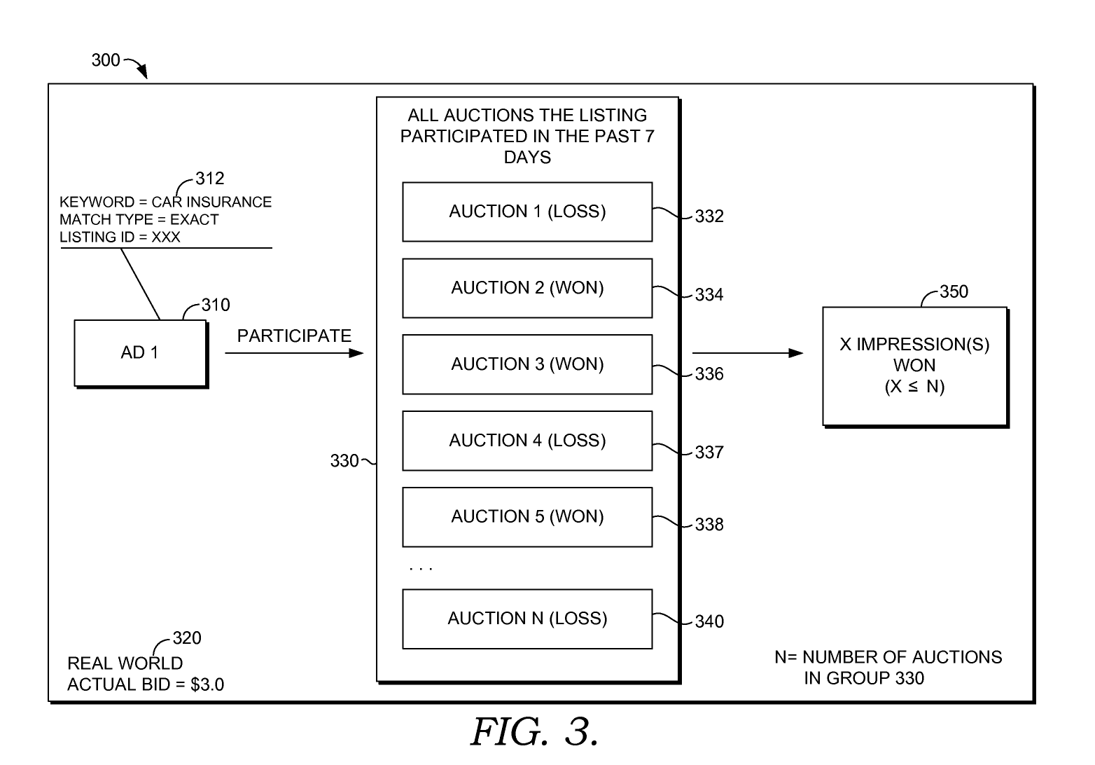

FIG. 3 illustrates how a listing 310 performed in a group of auctions 330 in which a listing participated with a first bid price 320. The listing 310 may be a paid search result. The listing is associated with bid characteristics 312. The bid characteristics include a keyword “car insurance.” The bid characteristics 312 also include a match type and a listing ID. In this case, an exact match is required for a listing 310 to participate in an auction. The bid price 320 may also be considered a bid characteristic. In this case, the real world actual bid 320 for listing 310 in when the listing participated in the group of actual auctions 330 was $3.00.

In the group of auctions 330, the listing 310 lost auction one 332, won auction two 334, won auction three 336, lost auction four 337, won auction five 338, and lost auction N 340. N represents the total number of auctions in group of auctions 330. A group of auctions 330 could include thousands of auctions. Only a few are shown, but auction N 340 represents the last auction. Thus, if 1,000 auctions were included in the group of auctions 330, then auction N 340 would the thousandth auction. For the sake of simplicity, in this case 994 additional auctions are not shown. Winning an auction may mean that the listing 310 received an impression because of the auction. In other words, the listing was displayed to a user in exchange for compensation. Further, in an actual auction, multiple listings may win in the sense that they receive an impression, but be ranked differently and shown in advertising space that is more or less favorable depending on the rank. Methods of calculating an advertisement's rank in an auction will be described in more detail below. The result of this group of auctions is X impressions won 350. In this case, since at least three losses occurred X is less than N.

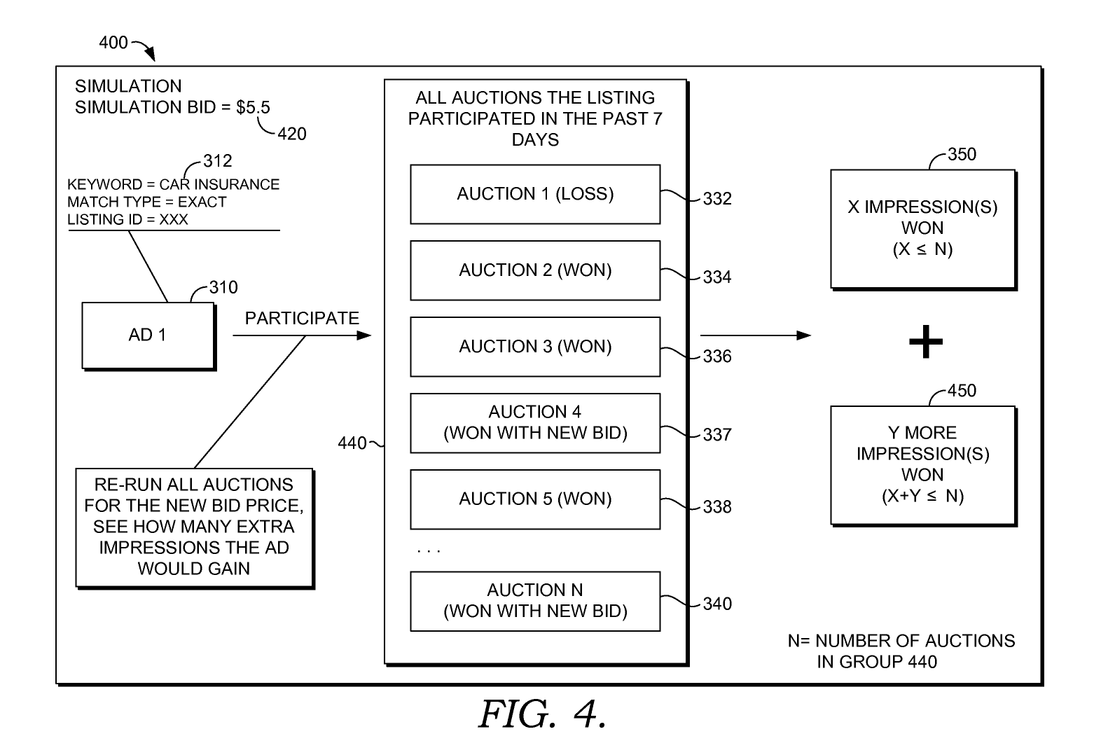

Turning now to FIG. 4, a diagram showing how the listing 310 performed when the group of auctions 440 in which a listing participated were rerun with a simulated bid price 420 for the listing is provided. As an initial step in a simulated auction, a group of auctions 440 in which a listing participated needs to be retrieved or identified to run the simulation. The group of auctions 440 may be selected using criteria that determines auctions that are most likely to produce results similar to those that will occur in a designated timeframe in the future. For example, the group of auctions 440 may be those that the listing participated in last week when the future designated time frame is next week. On the other hand, the criteria may determine that a particular keyword associated with the listing has much higher or lower bid prices during certain times of the year. For example, the keyword “flowers” may produce more impressions near Valentine's Day than during other times of the year and receive higher bid prices. In this case, the generation of a group of previously conducted auctions may take auctions conducted exactly one year ago to simulate results leading up to Valentine's Day next week.

In this case, the group of auctions 440 is selected from those in which the listing participated in the last seven days, which were shown in FIG. 3. The group of auctions is designated 440 and includes auctions 1 through N. N may be any number, but represents the total number of auctions in the group of auctions 440. For the sake of illustration, all of the auctions in the group of auctions 330 are shown in group of auctions 440. However, it is not necessary to take all auctions for the time period to conduct a simulation. For example, various filtering could be applied to eliminate auctions with extremely high or low bids that appear anomalous. Thus, N in FIG. 3 could be different from N in FIG. 4.

FIG. 4 shows the same ad listing 310 with the same bid characteristics 312. In this simulation, the simulated bid 420 is $5.50. As part of this simulation, each auction in the group of auctions 440 are rerun using the new bid price while maintaining the bid characteristics associated with all other listings that participated in the auctions. Advertising space is not actually sold through the simulation. As can be seen, with the new bid 420 auction four 337 flipped from a loss to a win. Similarly, auction N 340 also flipped from a loss to a win. Auction 1 332 remained a loss. As would be expected since the simulated bid price was larger than the actual bid price 320 the auction two 334, auction three 336, and auction five 338 all remained wins. This generated Y more impressions 450 than the auctions. The total impressions gained through the simulation can be calculated by adding X to Y. In one embodiment, this simulation is repeated for multiple bid prices to generate a distribution of bids and associated results. The distribution may be presented as a list, or a graph.

Turning now to FIG. 5, a method 500 of generating simulated auction results for an advertising listing is shown, in accordance with an embodiment of the present invention. At step 510, auction data for a plurality of advertising auctions in which a listing previously participated is retrieved. The listing is an advertising listing to purchase advertising space for the listing to be displayed. The listing previously participated in a group of auctions through which advertising space is sold. The advertising space may be paid for search results or a search results page. These advertising spaces are often associated with a keyword. Other types of advertising space that is sold in an online auction may also be simulated using method 500.

As mentioned, the auction data is for a plurality of advertising auctions in which the listing actually participated in the past. The listing may have won an auction or lost an auction described by the auction data. The auction data is selected for circumstantial conformity to a time period for which the simulation is being run. For example, if an advertiser wants to have a simulation run to understand how bids should be set for the listing in the coming week, then the auction data may be retrieved from auctions run the previous week. In many cases, the most recent auction data for a similar time period is best able to predict the results of future auctions. In other circumstances, auction data from a different past time period may be selected to produce a more relevant auction simulation. For example, an approaching holiday, such as Valentine's Day, Thanksgiving, or Christmas, may cause a dramatic shift in the performance of advertising listings. In this case, the best auction data may be gathered from auctions that the listing participated in a year ago from the time period being of interest. The auction data may be retrieved from a data store that is used to run the auction and stores actual advertising results, for example auction log 210.

In one embodiment, the auction data is filtered to eliminate anomalous auction results. For example, auctions with a successful listing price more than one standard deviation from the average winning listing price may be eliminated as an anomalous result. Other filters may be in place to detect anomalous auction data that may not be useful for predicting future results. Once the filtering is conducted, a set of auction data is completed.

At step 520, simulation results are generated by rerunning the plurality of advertising auctions using a simulated bid price for the listing that is different than an actual bid price for the listing while maintaining original bid prices for other listings that participated in the plurality of advertising auctions. In other words, the bid price for the listing being simulated is changed while bid prices for other listings that actually participated in the auctions is maintained. This generates new simulated results that may be different from the actual results that occurred in these auctions. The simulated auctions may be run with all the rules in place from the actual auction. For example, the listing that submits the highest bid is not necessarily the winning bid. In one embodiment, listings are assigned a rank score. The rank score may take into account factors such as previous performance of the listing, the bid price, and quality scores (indication of potential spam for example) for the listing. If the listing has a low-quality score or previously performed poorly (for example, it had a low-click-through rate) then the rank score may be lower than the rank score calculated for a second listing that had a lower-bid price but a higher-quality score and performance data. Embodiments of the present invention are not limited to using quality and performance data for calculating the rank score. Other factors may also be considered. In general, any factors used to calculate and rank and determine the winning auction in an actual auction may be used in the simulated auction.

In one embodiment, a whole series of simulated auctions are conducted to generate a distribution of impressions generated at different bid prices. There are different ways to generate the distribution. One way is to pick a series of simulated bid prices and rerun the auctions using those prices. The highest-simulated bid price may the highest price paid for an impression within the plurality of auctions. The other prices could be determined by incrementing the price down at even intervals. For example, if a distribution over 50 data points is desired then the highest price could be divided by 50 and then incremented downward accordingly. Thus, if the highest-winning bid is $10.00 and 50 data points are desired the auctions could be rerun with bids of $0.20, $0.40, $0.60 . . . $10.00.

A second method of generating data points is to find the simulated bid that results in a certain number of impressions. For example, if a total of 1,000 auctions are included then a winning bidder could obtain a maximum of 1,000 impressions. As before, if 50 data points are desired, then bid prices that result in 20 (which is 1,000/50), 40, 60, . . . 1000 impressions can be calculated.

Once the simulated auction results are generated, they may be presented a number of different ways. For example, the cost-per-click generated at a particular bid price may be one way to present the auction results. In another embodiment, a range of cost-per-click at different bid prices may be presented. The range may be presented as a graph or as a list. The cost-per-click or click-through-ratio may be generated using historical click-through-rates for the particular listing as well as historical click-through-rates for other listings that participated in the auctions. In one embodiment, the number of impressions or number of clicks obtained to the auction is obscured by using a factor. Multiplying the results by a factor could still allow the advertiser to determine the relative effectiveness of the bid price as compared to other bid prices. Ratios such as click-through-rates and cost-per-click may not need to be multiplied by the factor.

Turning now to FIG. 6, a method of simulating advertising auctions for a listing using historical data from actual auctions in which a listing participated is shown, in accordance with an embodiment of the present invention. As described previously, the auctions may be keyword auctions that are executed on an online advertising exchange. The online advertising exchange works by accepting listings for a keyword. The keyword may be within a search query or associated with content on a webpage. The actual online auction compares the rank of various listings to determine which listing wins the auction. The winner gets to have an advertisement associated with the listing displayed on the webpage. In some auctions, multiple winners are possible, especially where multiple placements on a webpage are available though a single auction. For example, a paid search listing may have eight or ten different positions on the webpage. In general, the listing with the highest rank will be given the most desirable advertising positions, the second ranked listing the second most desirable space, and so on. Embodiments of the present invention simulate both total impressions and, when multiple ad positions are available, the positions in which the impressions occur.

At step 610, a simulated average position within page search results is calculated for a listing by rerunning a group of previously conducted auctions in which the listing participated. The auctions are rerun using a simulated bid price for the listing that is different than an actual bid price for the listing used in the group of previously conducted auctions. The previously conducted auctions may be selected from a large group of auctions in which the listing previously participated. The group of previously conducted auctions may be selected because of their likelihood to produce simulated results similar to those expected to occur in a time period of interest. The simulated auctions are rerun with a new price or a bunch of different prices. At each simulated bid price, the simulated auction results may present the average placement of the listing. In another embodiment, the number of times the listing would be shown at each position is presented as a simulated auction result. In conjunction with the average listing position, the performance associated with showing the position at that location may also be calculated. The performance may be calculated using the performance of listings shown in that location in the simulated group of previously conducted auctions. The performance of the actual listing may also be a factor. In general, better positions provide better performance. In one embodiment, a position adjustment factor is calculated as the position performance of a particular position divided by the position performance of the best position. This factor may be multiplied by the position-independent performance of the listing to generate expected results at a particular position.

At step 620, the simulated average position is communicated to a listings advertiser. Other simulated auction results may be communicated along with the average position. A series of simulated auctions may be run to determine what bid price would result in a number of impressions or a percentage of all impressions at a particular position. The distribution should show that at a certain price the listing will receive 100% of the impressions at the best position. At a different price, the listing will receive 100% of the impressions but at a variety of positions. As the price lowers, the listing should receive less than 100% of the listings and position distribution will vary with the average position decreasing with simulated bid prices.

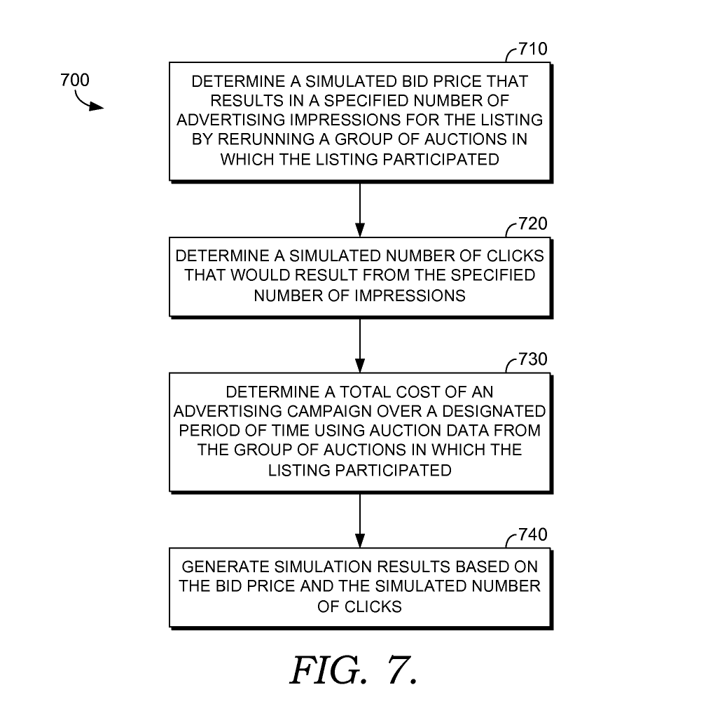

Turning now to FIG. 7, a method of generating simulated auction results for a listing using historical data from advertising auctions in which the listing previously participated is shown, in accordance with an embodiment of the present invention. At step 710, a simulated bid price that results in a specified number of advertising impressions is determined for the listing by rerunning a group of auctions in which the listing participated previously. The specified number of advertising impressions may be requested by the user for the simulation. For example, the user or advertiser may query the simulation application to ask at what bid price 100 advertising impressions would result. A single advertising impression is an instance of the listing being shown on a webpage. More specific data could be provided as a result of the auction simulation. For example, the total number of impressions at each of multiple positions on a website could be shared as a result of the simulation. The specified number could also be chosen to generate a distribution of results. As described previously, the specified number of impressions could be 1/50 or 1/25 of the total auctions and used to generate a distribution of results.

At step 720, a simulated number of clicks that would result from the specified number of impressions is determined. The total number of clicks may be determined using a historic click-through-rate for the listing. The historic click-through-rate for the listing may be adjusted based on the average listing location achieved during the simulated auction at the specified bid price. For example, the click-through-rate of the listing in the auction may be adjusted by multiplying it times a placement ratio. The placement ratio may be the click-through-rate at the average ad position achieved during the simulated auctions divided by the click-through-rate for the top or best advertisement position. This ratio helps correct for different performances achieved at different placements on the webpage.

At step 730, a total cost of an advertisement campaign over a designated period of time using auction data from the group of auctions in which the listing participated is determined. The total cost may be calculated by using the simulated auction data. The total cost would be calculated differently depending on the bid methodology used in the actual auction and thus in the simulated auction. In one embodiment, it could be calculated using generalized second-placed auction pricing rules. In this case, the advertisement pays for the advertisement space based on the bid price of the listing just below the simulated listing. If the listing in the simulated auction shows up in the last spot on a group of available ad positions, then a minimum threshold amount (e.g., $0.05) may be used for the impression price. Embodiments of the present invention are not limited to this type of auction pricing, the total cost of the auction may be calculated using any known auction pricing methodology.

At step 740, simulation results are generated based on the simulated price and the simulated number of clicks. This method 700 may be repeated at multiple different specified number of advertising impressions to create a distribution of advertising impression-to-bid price result sets. The result sets may be presented as a list or on a graph or through some other method. The result set allows an advertiser to pick a bid price that could result in desired results if the selected group of previously conducted auctions accurately predict the results from yet to be conducted auctions.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-readable media having computer-executable instructions embodied thereon that when executed by a computing device perform a method of generating simulated auction results for an advertisement listing, the method comprising:
retrieving auction data for a plurality of advertising auctions in which a listing previously participated;
generating simulation results by rerunning the plurality of advertising auctions using a simulated bid price for the listing that is different than an actual bid price for the listing while maintaining original bid prices for other listings that participated in the plurality of advertising auctions; and
storing the simulation results.

2. The media of claim 1, wherein the plurality of advertising auctions were for keyword advertisements.

3. The media of claim 1, wherein the method further comprises rerunning the plurality of advertising auctions using a plurality of bid prices to determine a bid price that results in a desired number of impressions.

4. The media of claim 1, wherein the simulation results comprise a list of impressions generated at the simulated bid price.

5. The media of claim 1, wherein the simulation results comprise a cost-per-click for the simulated bid price.

6. The media of claim 1, wherein the method further comprises calculating a bid price that results in a simulated threshold percentage of impressions at a position within paid search results.

7. The media of claim 1, wherein the method further comprises determining the plurality of advertising auctions that are most likely to predict results in auctions occurring during a future time frame.

8. A method of simulating advertising auctions for a listing using historical data from actual auctions in which the listing participated, the method comprising:
calculating, at a computing device, a simulated average position within paid search results for a listing by rerunning a group of previously conducted auctions in which the listing participated using a simulated bid price for the listing that is different than an actual bid price for the listing used in the group of previously conducted auctions; and
communicating the simulated average position to the listing's advertiser.

9. The method of claim 8, wherein the method further comprises rerunning the group of previously conducted auctions using a plurality of bid prices to determine a bid price that results in a desired number of impressions at a particular location within the paid search results.

10. The method of claim 8, wherein the method further comprises rerunning the group of previously conducted auctions using a plurality of bid prices to determine a bid price that results in a desired number of clicks at a particular location within the paid search results.

11. The method of claim 8, wherein the method further comprises rerunning the group of previously conducted auctions using a plurality of bid prices to generate a distribution of bid prices that results in a desired number of impressions at different locations within the paid search results.

12. The method of claim 8, wherein the method further comprises determining the group of previously conducted auctions that are most likely to predict results in auctions occurring during a future time frame.

13. One or more computer-readable media having computer-executable instructions embodied thereon that when executed by a computing device perform a method of generating simulated auction results for a listing using historical data from advertising auctions in which the listing previously participated, the method comprising:
determining a simulated bid price that results in a specified number of advertising impressions for the listing by rerunning a group of auctions in which the listing participated;
determining a simulated number of clicks that would result from the specified number of advertising impressions;
determining a total cost of an advertising campaign over a designated period of time using auction data from the group of auctions in which the listing participated; and
generating simulation results based on the simulated bid price and the simulated number of clicks.

14. The media of claim 13, wherein the simulation results comprise a click-through-rate for the simulated bid price.

15. The media of claim 13, wherein the simulation results comprise a cost-per-click for the simulated bid price.

16. The media of claim 13, wherein the simulation results comprise a graph showing a distribution of simulated bid prices vs. a simulated auction result of each of several simulated bid prices.

17. The media of claim 13, wherein the simulation results comprise a distribution showing different simulated auction results occurring at different simulated bid prices.

18. The media of claim 13, wherein said determining the simulated bid price further comprises calculating a simulated rank score within an previously conducted auction and comparing the simulated rank score with rank scores for other listings that participated in the auction to determine whether the simulated rank score is above a lowest-rank score for a listing that received an impression through the auction.

19. The media of claim 13, wherein said determining the simulated number of clicks that would result from the specified number of advertising impressions comprises, adding a click potential for each simulated auction resulting in an impression, wherein the click potential of each auction is calculated my multiplying a click-through-rate for the listing times a position adjustment factor that is based on a position achieved in the simulated auction.

20. The media of claim 19, wherein the method further comprises calculating an average position within the listing for the simulated bid price.
